(19) United States
(12) Patent Application Publication
(10) Pub. No.: US 2010/0310112 A1
(43) Pub. Date: Dec. 9, 2010

(54) DIAPHRAGM AND MICRO-ELECTROACOUSTIC DEVICE INCORPORATING THE SAME

(75) Inventor: HWANG-MIAW CHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/562,075

(22) Filed: Sep. 17, 2009

(30) Foreign Application Priority Data
Jun. 3, 2009 (CN) 200910302879.4

(51) Int. Cl. H04R 1/00; H04R 7/00

(52) U.S. Cl. 381/433; 181/173

(57) ABSTRACT

A diaphragm includes a central portion in a center of the diaphragm, a pleat portion surrounding the central portion and a flange surrounding the pleat portion. A plurality of pleats are defined in the pleat portion and extend from the central portion to the flange along a tangential direction of the central portion.

### BACKGROUND

1. Technical Field

The present invention relates generally to a micro-electroacoustic device, and more particularly to a diaphragm of a micro-electroacoustic device.

2. Description of Related Art

Sound is one important means by which people communicate with each other; thus, creating new methods for sound transference allows greater communication between people. Electroacoustic transducers are key components in transferring sound. A typical electroacoustic transducer has a magnetic circuit in which a magnetic field generated by a magnet passes through a base member, a magnetic core and a diaphragm and returns to the magnet again. When an oscillating electric current is supplied to a coil wound around the magnetic core, the corresponding oscillating magnetic field generated by the coil is then superimposed onto the magnetostatic field of the magnetic circuit. The resulting oscillation generated in the diaphragm is then transmitted to the air as sound. The basic loudspeaker, in which electric energy is converted to acoustic energy, is a typical electroacoustic transducer. There are many different types of loudspeakers, including electrostatic loudspeakers, piezoelectric loudspeakers, and moving-coil loudspeakers.

Nowadays, mobile phones are widely used and loudspeakers are important components packaged within the mobile phones. As design style for the mobile phones emphasizes lightness, thinness, shortness, smallness, energy-efficiency and low cost; the space available for the loudspeakers within the mobile phones is therefore limited. Furthermore, a rigidity of the diaphragm of the loudspeakers needs to increase for decreasing a radial movement during oscillation.

For the foregoing reasons, therefore, there is a need in the art for a diaphragm which can meet the requirements.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a micro-electroacoustic device according to an exemplary embodiment.

FIG. 2 is a cross-sectional view of the micro-electroacoustic device of FIG. 1, taken along line II-II thereof.

FIG. 3 is an exploded view of the micro-electroacoustic device of FIG. 1.

FIG. 4 is a top, plan view of a diaphragm of the micro-electroacoustic device of FIG. 1.

FIG. 5 is a graph indicating sound distortion coefficients of the present diaphragm and a related diaphragm.

FIG. 6 is a top, plan view of a diaphragm of a micro-electroacoustic device of a second exemplary embodiment.

### DETAILED DESCRIPTION

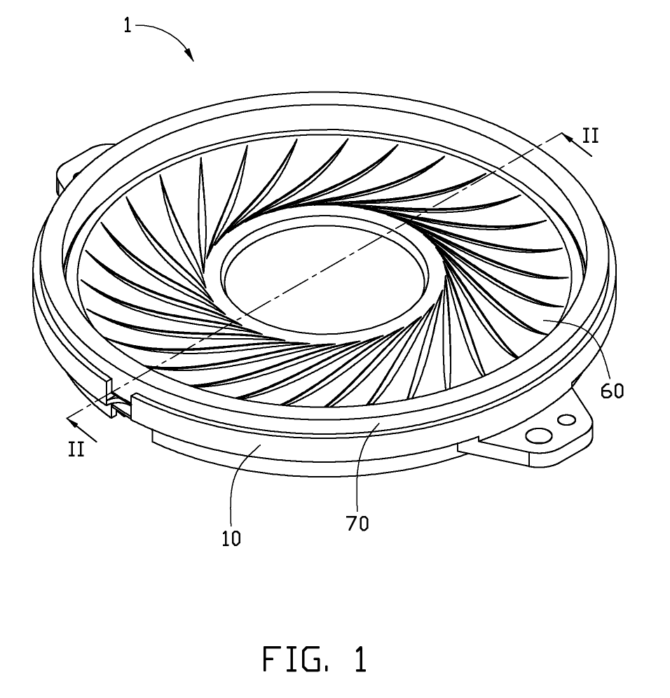

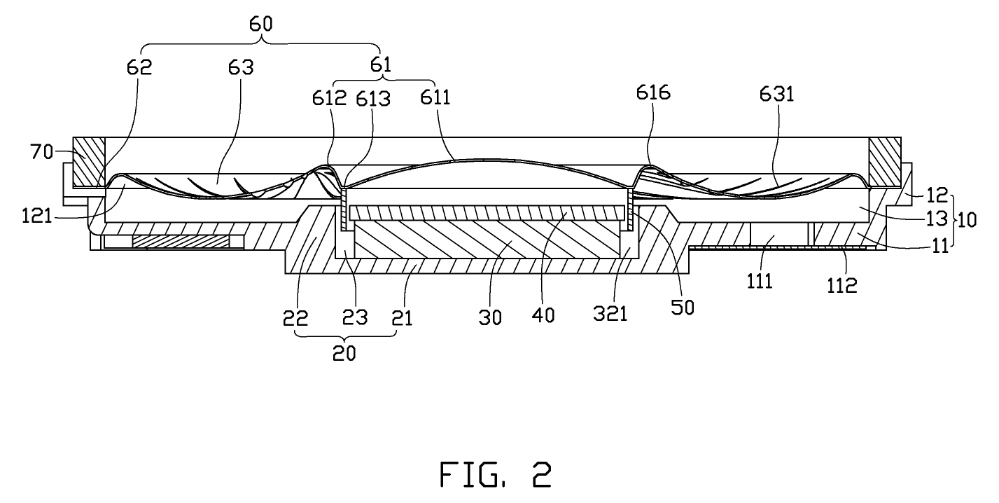

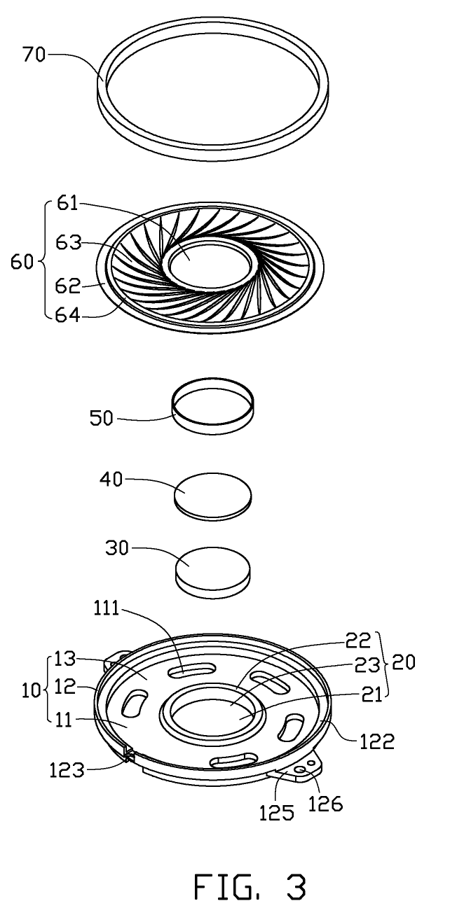

Referring to FIGS. 1-3, a micro-electroacoustic device 1 includes a frame 10, a cylindrical yoke 20 engaged with the frame 10, a column-shaped magnet 30 disposed in the cylindrical yoke 20, a circular film-shaped washer 40 located on the magnet 30, a hollow cylinder-shaped coil 50 surrounding the magnet 30, a film-shaped diaphragm 60 attached to the frame 10 and an annular pad 70 made of a material selected from paper or plastic and securing a periphery of the diaphragm 60 to the frame 10.

The frame 10 includes a circular base plate 11 and a side plate 12 extending upwardly and perpendicularly from an outer periphery of the base plate 11. The frame 10 defines a receiving chamber 13 therein. An annular step 122 is formed at an inner peripheral surface of the side plate 12 and extends radially and inwardly from the inner peripheral surface of the side plate 12 of the frame 10 towards the receiving chamber 13. Two opposite mounting arms 125 extend radially and outwardly from an outer peripheral surface of the side plate 12 of the frame 10. Each of the mounting arms 125 defines two mounting holes 126 for mounting the micro-electroacoustic device 1 onto an electrical device such as a mobile phone or a notebook computer (not shown). A groove 123 is defined in the side plate 12 of the frame 10 for receiving electrical lines.

The cylindrical yoke 20 is integrally formed with the frame 10 and disposed in a center of the base plate 11 of the frame 10. The cylindrical yoke 20 includes a circular base wall 21 and a side wall 22 extending upwardly from an outer periphery of the base wall 21 and connected with the base plate 11 of the frame 10. The cylindrical yoke 20 defines a receiving space 23 therein. The receiving chamber 13 of the frame 10 communicates with the receiving space 23 of the cylindrical yoke 20. A plurality of through holes 111 are defined in the base plate 11 of the frame 10 surrounding the cylindrical yoke 20. An acoustic material 112 is disposed on a bottom surface of the frame 10 and covers the through hole 111 of the frame 10.

The magnet 30 and the washer 40 are received in the receiving space 23 of the cylindrical yoke 20 and coaxial with the cylindrical yoke 20. The magnet 30 is mounted on the base wall 21 of the cylindrical yoke 20. The washer 40 is mounted on the magnet 30. An inner diameter of the cylindrical yoke 20 is larger than an outer diameter of the magnet 30 and an outer diameter of the washer 40, whereby the side wall 22 of the cylindrical yoke 20, an outer peripheral surface of the magnet 30 and an outer peripheral surface of the washer 40 cooperatively define an annular air space 321 therebetween for accommodating the coil 50 therein. The coil 50 surrounds the magnet 30 and the washer 40 and is movable in the annular air space 321.

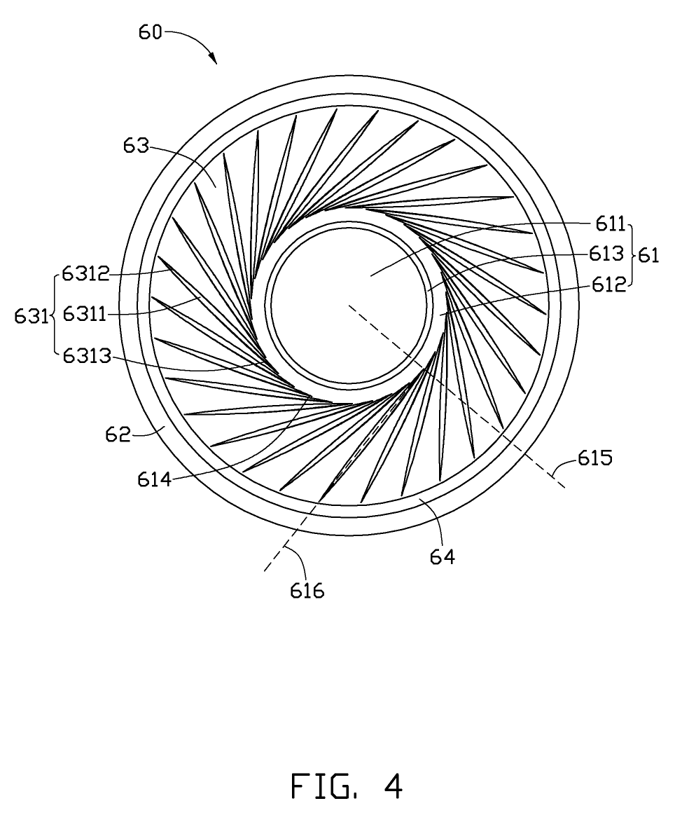

Referring also to FIG. 4, the diaphragm 60 is circular in profile. The diaphragm 60 includes a central portion 61 in a center thereof, an annular pleat portion 63 surrounding the central portion 61, a first protrusion 64 surrounding the pleat portion 63 and an annular flange 62 extending radially and outwardly from an outer peripheral edge of the first protrusion 64. The flange 62 of the diaphragm 60 is attached to the step 122 of the frame 10 and the annular pad 70 is disposed on the flange 62 of the diaphragm 60 thereby fixing the diaphragm 60 onto the frame 10. A top side of the annular pad 70 engages with the electrical device. The annular pad 70 has a greater height than the diaphragm 60 thereby preventing the diaphragm 60 from touching the electrical device during a vibration of the diaphragm 60.

The central portion 61 includes a dome-shaped central section 611 in a center of the central portion 61, a protruding section 612 at an outer periphery of the central portion 61 and an annular connecting section 613 between the central section 611 and the protruding section 612. A top side of the coil 50 is attached to a bottom surface of the connecting section 613 of the central portion 61 of the diaphragm 60.

The pleat portion 63 is curved downwardly like an annular valley and disposed between the annular flange 62 and the central portion 61. The central section 611 of the central portion 61 and the pleat portion 63 improve a rigidity of the diaphragm 60 thereby preventing the diaphragm 60 from abrupt and exceeding deformation during vibration of the diaphragm 60 since the central section 611 is upwardly protruded and the pleat portion 63 is downwardly depressed.

A plurality of pleats 631 are defined in a top surface of the pleat portion 63. Each pleat 631 extends from the central portion 61 towards the annular flange 62 along a tangential direction of the central portion 61. The plurality of pleats 631 are clockwise arranged around the central portion 61 and extend outwardly from an annular outer peripheral edge 614 of the protruding section 612. Each of the pleats 631 has a V-shaped cross section and includes a middle section 6311 at a middle of the pleat 631 and first and second ends 6312, 6313 at two opposite sides of the middle section 6311, wherein the first end 6312 is located adjacent to the annular flange 62 and the second end 6313 is located adjacent to the central portion 61. A width of the pleat 631 decreases from the middle section 6311 of the pleat 631 towards the first end 6312 and the second end 6313 of the pleat 631, whereby the middle section 6311 of the pleat 631 has a larger width than each of the first end 6312 and the second end 6313 of the pleat 631. A radial line 615 of the central portion 61 passing the second end 6313 of a corresponding pleat 631 is perpendicular to a center line 616 of the corresponding pleat 631 thereby decreasing a radial vibration of the diaphragm 60 to decrease a distortion of the micro-electroacoustic device 1 and improve a sound quality of the micro-electroacoustic device 1.

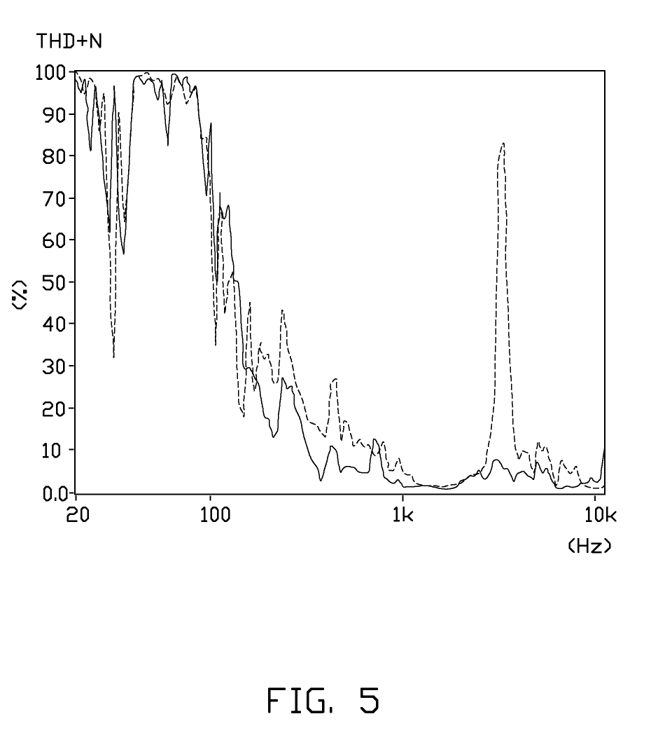

FIG. 5 shows sound distortion coefficients of the present diaphragm 60 and a related diaphragm. The solid curve in FIG. 5 shows a distortion coefficient of the present diaphragm 60 and the broken curve in FIG. 5 shows a distortion coefficient of the related diaphragm. The related diaphragm has a same structure as the present diaphragm except that the center line of the pleat of the related diaphragm is oriented with an angle of 55 degrees with respect to the radial line of the central portion of the related diaphragm passing the second end of the pleat. The solid curve is lower than the broken curve at a frequency ranging from 1 k Hz to 10 k Hz, whereby the presented diaphragm 60 has a lower distortion coefficient than the related diaphragm.

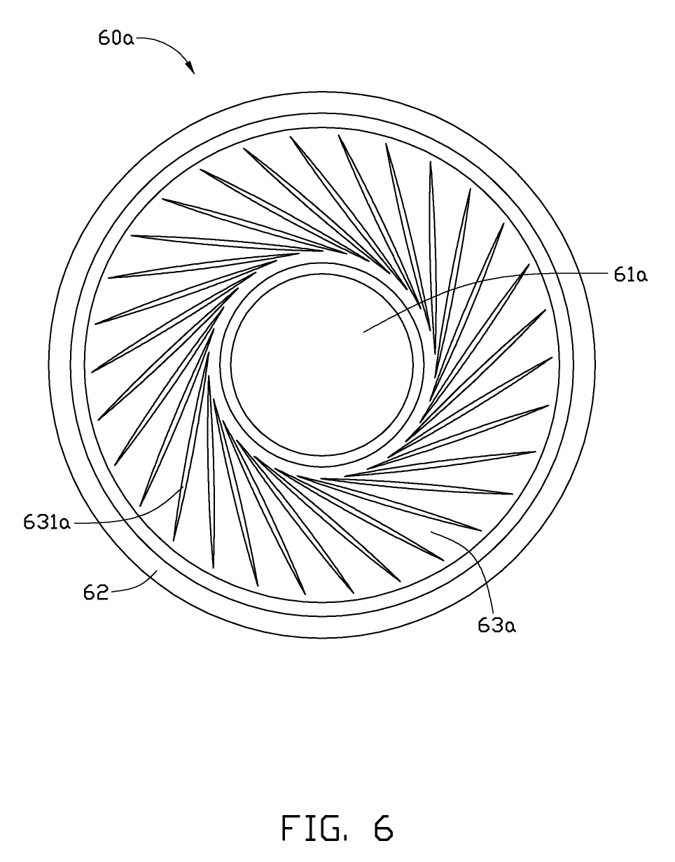

FIG. 6 shows an alternative embodiment. The difference of this embodiment over the previous embodiment is as follows. The plurality of pleats 631a formed at the pleat portion 63a are anti-clockwise arranged around the central portion 61a of the diaphragm 60a.

It will be obvious that, within the scope of the invention, many variations are possible to those skilled in the art. The scope of protection of the invention is not limited to the example given herein.

What is claimed is:

1. A diaphragm comprising:
a central portion in a center of the diaphragm;
a pleat portion surrounding the central portion; and
a flange surrounding the pleat portion;
wherein a plurality of pleats are defined in the pleat portion and extend from the central portion to the flange along a tangential direction of the central portion.

2. The diaphragm as claimed in claim 1, wherein the plurality of pleats are clockwise arranged around the central portion.

3. The diaphragm as claimed in claim 1, wherein the plurality of pleats are anti-clockwise arranged around the central portion.

4. The diaphragm as claimed in claim 1, wherein each of the plurality of pleats has a V-shaped cross section.

5. The diaphragm as claimed in claim 4, wherein a width of each of the plurality of pleats decreases from a middle of each of the plurality of pleats to two ends of each of the plurality of pleats.

6. The diaphragm as claimed in claim 1, wherein the central portion comprises a dome-shaped central section in a center of the central portion, a protruding section at an outer periphery of the central portion and an annular connecting section between the central section and the protruding section, the pleat portion being curved downwardly like an annular valley.

7. The diaphragm as claimed in claim 1, wherein each of the pleats includes first and second ends and a middle section between the first and second ends, the first end is located adjacent to the flange and the second end is located adjacent to the central portion, a radial line of the central portion passing the second end of a corresponding pleat is perpendicular to a center line of the corresponding pleat.

8. A micro-electroacoustic device comprising:
a frame;
a magnet received in the frame;
a coil surrounding the magnet; and
a diaphragm attached to the frame, the diaphragm comprising:
a central portion in a center of the diaphragm;
a pleat portion surrounding the central portion; and
a flange surrounding the pleat portion;
wherein a plurality of pleats are defined in the pleat portion and extend from the central portion to the flange along a tangential direction of the central portion.

9. The micro-electroacoustic device as claimed in claim 8, wherein the plurality of pleats are clockwise arranged around the central portion.

10. The micro-electroacoustic device as claimed in claim 8, wherein the plurality of pleats are anti-clockwise arranged around the central portion.

11. The micro-electroacoustic device as claimed in claim 8, wherein each of the plurality of pleats has a V-shaped cross section.

12. The micro-electroacoustic device as claimed in claim 8, wherein a width of each of the plurality of pleats decreases from a middle of each of the plurality of pleats to two ends of each of the plurality of pleats.

13. The micro-electroacoustic device as claimed in claim 8, wherein the central portion comprises a dome-shaped central section in a center of the central portion, a protruding section at an outer periphery of the central portion and an annular connecting section between the central section and the protruding section, the pleat portion being curved downwardly like an annular valley.

14. The micro-electroacoustic device as claimed in claim 8, wherein each of the pleats includes first and second ends and a middle section between the first and second ends, the first end is located adjacent to the flange and the second end is located adjacent to the central portion, a radial line of the central portion passing the second end of a corresponding pleat is perpendicular to a center line of the corresponding pleat.

15. The micro-electroacoustic device as claimed in claim 8, wherein the frame comprises a base plate and a side plate extending upwardly from an outer periphery of the base plate, the frame defining a receiving chamber therein, a step being formed at an inner peripheral surface of the side plate and extending radially and inwardly from the inner peripheral surface of the side plate of the frame towards the receiving chamber.

16. The micro-electroacoustic device as claimed in claim 15 further comprising a yoke disposed in the receiving chamber of the frame and a washer disposed on the magnet, the yoke comprising a circular base wall attached to the base plate of the frame and a side wall extending upwardly from an outer periphery of the base wall, the yoke defining a receiving space communicating with the receiving chamber of the frame, the magnet and the washer being received in the receiving space of the yoke, the magnet being mounted on the base wall of the yoke.

17. The micro-electroacoustic device as claimed in claim 8, wherein the diaphragm further comprises a flange extending radially and outwardly from an outer peripheral edge of the first protrusion, the flange of the diaphragm being attached to the step of the frame.

18. The micro-electroacoustic device as claimed in claim 17 further comprising an annular pad disposed on the flange of the diaphragm for fixing the diaphragm onto the frame, the annular pad having a greater height than the diaphragm.
